(19) United States
(12) Patent Application Publication
(10) Pub. No.: US 2014/0345378 A1
(43) Pub. Date: Nov. 27, 2014

(54) METHOD FOR OPERATING A RATE-OF-ROTATION SENSOR

(71) Applicants: Thomas NORTHEMANN, Gerlingen (DE); Jens STROBEL, Freiberg Am Neckar (DE)

(72) Inventors: Thomas NORTHEMANN, Gerlingen (DE); Jens STROBEL, Freiberg Am Neckar (DE)

(73) Assignee: Robert Bosch GmbH, Stuttgart (DE)

(21) Appl. No.: 14/272,716

(22) Filed: May 8, 2014

(30) Foreign Application Priority Data
May 14, 2013 (DE) 10 2013 208 822.1

(51) Int. Cl. G01C 19/5762

(52) U.S. Cl. CPC G01C 19/5762
USPC 73/504.12

(57) ABSTRACT

In a method for operating a rotation rate sensor including a substrate and a seismic mass, the seismic mass is driven in a drive direction in parallel to the main extension plane of the sensor to carry out a drive movement, and, during a rotation of the rotation rate sensor, the seismic mass is moved in a detection direction perpendicular to the drive direction and perpendicular to the rotation rate as a result of the action of force caused by the Coriolis force. The movement in the detection direction has a deflection amplitude, and the rotation rate sensor includes a deflection support element acting on the seismic mass in such a way that the deflection amplitude in the detection direction is increased.

### BACKGROUND OF THE INVENTION

1. Field of the Invention

The present invention relates to a rotation rate sensor.

2. Description of the Related Art

Such rotation rate sensors are known from the published European patent document EP 1 123 484 B1, for example, and are very common for the determination of rotation rates. To achieve a preferably high sensitivity, it is generally desirable for the seismic mass to be deflected by the Coriolis force preferably far with respect to a drive axis along which the drive movement takes place. It has become established to lower the pressure of the atmosphere in which the seismic mass is moved to reduce the friction which occurs during the movement of the seismic mass, and thereby achieve larger deflections.

Moreover, micromechanical devices are gaining in importance, which include an acceleration sensor in addition to a rotation rate sensor. Acceleration sensors are preferably operated at approximately 500 times the pressure (compared to the rotation rate sensor). If the rotation rate sensor and the acceleration sensor now share an atmosphere (e.g., in a shared cavity) at the pressure which is provided for the acceleration sensor, the sensitivity of the rotation rate sensor is considerably reduced. While the related art provides for the rotation rate sensor and the acceleration sensor to be combined on a micromechanical device, it thus also provides for ensuring that the seismic masses have different atmospheres available, the pressure in the cavern being adapted in each case to the sensor type. This approach is generally associated with added complexity and costs since additionally getter materials and/or additional structuring measures for the micromechanical component are required.

### BRIEF SUMMARY OF THE INVENTION

It is the object of the present invention to provide a rotation rate sensor, whose sensitivity is improved for the measurements of the rotation rates, without changing the atmosphere.

The object is achieved by a method for operating a rotation rate sensor including a substrate and a seismic mass, the rotation rate sensor having a main extension plane, the seismic mass being driven in a drive direction which extends in parallel to the main extension plane to carry out a drive movement, and, during a rotation of the rotation rate sensor at a rotation rate, the seismic mass being moved in a detection direction which extends perpendicularly to the drive direction and perpendicularly to the rotation rate as a result of the action of force caused by the Coriolis force. It is provided according to the present invention that a movement in the detection direction has a deflection amplitude, and the rotation rate sensor includes a deflection support means, the deflection support means acting on the seismic mass in such a way that the deflection amplitude of the seismic mass in the detection direction is increased, in particular compared to a rotation rate sensor which is operated without deflection support means. The seismic mass is typically connected to the substrate via at least one detection spring and/or at least one mainspring.

The movement of the seismic mass in the detection direction typically includes a deflection movement and a return movement, the seismic mass assuming the deflection amplitude at the end of the deflection movement and at the beginning of the return movement, and the return movement being complete when the seismic mass, during the return movement, has covered a distance which is identical, in terms of magnitude, to the deflection amplitude or is being returned to a drive axis along which essentially the drive movement of the seismic mass takes place. When the seismic mass assumes a position on the drive axis, this position is referred to hereafter as the zero point position. The seismic mass in particular assumes the zero point position when no Coriolis force acts on the mass, i.e., when no rotation rate is present.

It is provided that the deflection support means exerts a supporting force action on the seismic mass, the supporting force action and the movement of the seismic mass in the detection direction pointing in the same direction at least temporarily. In particular, it is provided that the seismic mass moves in the detection direction between a zero point position and the deflection amplitude, the supporting force action transferred by the deflection support means to the seismic mass during the movement of the seismic mass from the zero point position to the deflection amplitude being greater, in sum, than the supporting force action transferred from the deflection support means to the seismic mass during the movement of the seismic mass from the deflection amplitude to the zero point position, the direction of the supporting force action extending in parallel to the detection direction. The supporting force action may take place over a short time interval and/or continuously during the entire movement in the detection direction. In this specific embodiment of the method according to the present invention, the deflection amplitude is increased, and consequently the sensitivity of the rotation rate sensor is also advantageously improved.

In one further specific embodiment, a briefly occurring supporting force action becomes maximal during the deflection movement. As an alternative, the supporting force action could already be maximal, or occur, during the return movement to increase the deflection amplitude during the subsequent deflection movement.

The seismic mass is preferably driven by two drive electrodes which are situated along the drive direction and between which the seismic mass is situated. The drive electrodes usually have comb drive structures. It is typically provided for this purpose that a drive voltage at the drive electrodes changes periodically with the drive frequency, a first drive voltage at one drive electrode being out-of-phase by 180° with respect to a second drive voltage at a second drive electrode.

The rotation rate sensor usually has a detection means, the detection means including two detection electrodes which are situated along the detection direction and between which the seismic mass is situated.

In one preferred specific embodiment, the seismic mass is driven to carry out a periodic movement, in particular to carry out a periodic linear movement, with a drive frequency in the drive direction. In one particularly preferred specific embodiment, it is provided that the increase in the deflection amplitude is achieved by a parametric amplification. In a parametric amplification, the oscillating system absorbs energy from outside. If a fictitious spring is assigned to the oscillation in the detection direction, the absorption of the energy may be described based on the system's spring constant. It is provided, on the one hand, that the spring constant is reduced at least temporarily during the deflection movement (compared to the spring constant without deflection support means), and thus higher deflection amplitudes may be achieved. It is provided, on the other hand, that the spring constant is increased at least temporarily during the restoring movement (compared to the spring constant without deflection support means), and thus the speed during traversing of the drive axis is greater. To achieve a parametric amplification over the entire period of a detection oscillation, it is necessary for the spring constant to become hard twice and soft twice in each case, i.e., the deflection support means has a deflection support frequency which is twice as high as the drive frequency.

It is provided for this purpose that the deflection support means provided for changing the spring constant includes two deflection support electrodes which are situated in parallel to each other and along the detection direction and between which the seismic mass is situated. In particular, it is provided that a deflection support voltage between the deflection support electrodes changes periodically with the deflection support frequency, the deflection support voltage maintaining its sign.

If the deflection support voltage causes a change of the spring constant, it is particularly advantageous that the time during which the spring is soft essentially covers the time interval of the deflection movement and only a short time interval of the return movement.

In one particularly advantageous specific embodiment, it is provided that the spring is soft during the entire deflection movement and hard when the return movement takes place.

If the supporting force action takes place in the described manner, this causes not only an increase in the deflection amplitude, but also damping of a quadrature signal. The quadrature signal is the result of imperfections of the real rotation rate sensor which arise during the sensor's manufacture, and ensures that the measured detection signal is not only proportional to the rotation rate, but also includes contributions from the quadrature signal. The quadrature signal is in phase with the drive movement of the seismic mass, i.e., a quadrature deflection is the greatest when the drive deflection becomes maximal. At this point in time, the Coriolis force proportional to the speed of the seismic mass is the lowest. At the same time, it is provided in the specific embodiment that the supporting force action is opposed to the quadrature signal, i.e., its quadrature deflection movement. The quadrature signal is thus advantageously reduced or attenuated.

In one further specific embodiment, it is provided that the rotation rate sensor includes a drive support means, the drive support means increasing a drive amplitude of the drive movement of the seismic mass in the drive direction. The magnitude of the deflection amplitude is thus indirectly influenced. It is provided that the drive movement on average becomes faster as a result of the additional drive support means. A faster movement in the drive direction increases the Coriolis force and, in addition to the deflection support means, may thus contribute to an increase in the deflection amplitude. It is thus advantageously possible to ensure that the deflection amplitude becomes even larger and the rotation rate sensor even more sensitive.

In one particularly preferred specific embodiment, the rotation rate sensor shares a cavity/cavern with an acceleration sensor. If the pressure which prevails in the cavity is that which is provided for the optimal operation of the acceleration sensor, the rotation rate sensor may advantageously compensate for the loss caused thereby by being operated according to the present invention.

Another subject matter of the present invention is a device which includes at least one rotation rate sensor and at least one acceleration sensor, the rotation rate sensor and the acceleration sensor being operated in a shared atmosphere, in particular in a cavern in which the rotation rate sensor and the acceleration sensor are situated under the same pressure, preferably according to the requirements of the acceleration sensor and the rotation rate sensor according to one of the methods according to the present invention.

### BRIEF DESCRIPTION OF THE DRAWINGS

FIG. 1 is a schematic illustration of a rotation rate sensor which is provided for the method according to the present invention for operating the rotation rate sensor.

FIG. 2 is a tabular illustration of the time dependencies of a deflection movement in the detection direction, a periodically varying deflection support voltage, and a quadrature signal, as well as state descriptions of a fictitious spring which changes its spring constant.

FIG. 3 shows a graph which illustrates an amplification of a deflection amplitude or of a quadrature signal as a function of the phase of the deflection support voltage.

FIG. 4 shows a device in which an acceleration sensor and a rotation rate sensor share a cavern.

### DETAILED DESCRIPTION OF THE INVENTION

Identical parts are always denoted by the same reference numerals in the various figures and are therefore generally also cited or mentioned only once.

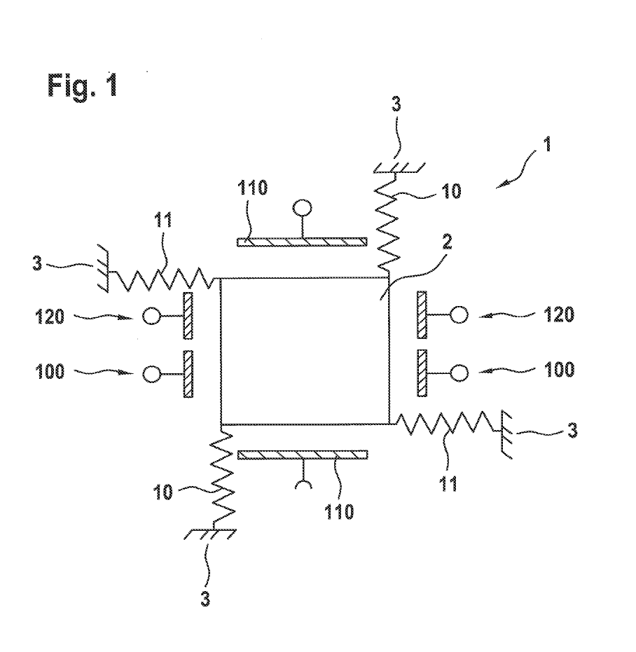

FIG. 1 shows one specific embodiment of a rotation rate sensor 1 which has a main extension plane and includes a substrate 3 and a seismic mass 2. Seismic mass 2 is resiliently coupled to substrate 3 via at least one mainspring 10 (in the specific embodiment shown, via two) and at least one detection spring 11 (in the specific embodiment shown, via two), whereby seismic mass 2 is able to move relative to substrate 3 in a direction parallel to the main extension plane. With the aid of a drive means 110, it is possible to cause seismic mass 2 to carry out a periodic movement, in particular a periodic linear movement, along a drive direction. The axis along which seismic mass 2 is essentially moved in the drive direction is referred to here as the drive axis.

With a real rotation rate sensor, it is generally not possible to ensure that the drive movement takes place along a straight line; rather, the drive axis reflects a general course which seismic mass 2 follows during its drive movement. In the shown specific embodiment, drive means 110 is drive electrodes, which are situated as a pair with respect to each other in such a way that seismic mass 2 is present between the drive electrodes. In particular, drive electrodes 110 generally include comb drive structures. When rotation rate sensor 1 undergoes a rotational movement having a rotation rate perpendicular to the drive direction (or a rotation rate having a component which extends perpendicularly to the drive direction), a Coriolis force acts perpendicularly to the drive direction and perpendicularly to the rotation rate, whereby a detection movement of seismic mass 2 along a detection direction is caused. The detection direction extends
perpendicularly to the drive direction according to a first specific embodiment, and parallel to the main extension plane in the shown specific embodiment; and
perpendicularly to the drive direction and perpendicularly to the main extension plane of rotation rate sensor 1 according to a second specific embodiment. To be able to quantify the detection movement, the rotation rate sensor includes detection means 100. Detection means 100 are usually electrodes, which are an integral part of the substrate and the seismic mass. The detection movement caused by the Coriolis force includes a deflection movement and a return movement, the deflection movement denoting the part of the detection movement which leads seismic mass 2 away from the drive axis, while the return movement returns seismic mass 2 to the drive axis. The maximally assumed relative distance from the drive axis during the deflection movement is referred to as the deflection amplitude. Disregarding potential disturbance influences (e.g., an acceleration in the detection direction or quadrature signals), the deflection amplitude is essentially dependent on the magnitude of the Coriolis force, and thus on the drive speed and the magnitude of the rotation rate (or the contributing component of the rotation rate). It is thus possible to assign a rotation rate to any deflection amplitude since the drive speed is generally known. The following applies: If two rotation rate sensors (which have the same drive speed) differ in their deflection amplitude at the same Coriolis force, the rotation rate sensor whose deflection amplitude is larger will usually be more sensitive. To increase the deflection amplitude at the same Coriolis force, according to the present invention the rotation rate sensor in the shown specific embodiment includes a deflection support means 120. The task of deflection support means 120 is to increase the deflection amplitude. It is provided that deflection support means 120 supports the movement of the seismic mass in the detection direction. According to the present invention, deflection support means 120 is designed in such a way that a supporting force action originating from it acts on seismic mass 2, the force action taking place in parallel to the movement of the seismic mass in the detection direction, and therefore having to be temporally coordinated with the same. The support may take place continuously or at one particular point in time, or multiple particular points in time, during the deflection movement and/or the return movement of the seismic mass. In the specific embodiment shown in FIG. 1, deflection support means 120 includes two deflection support electrodes which are situated along the detection direction and between which the seismic mass is situated. In particular, the deflection support electrodes may include additional comb drive structures.

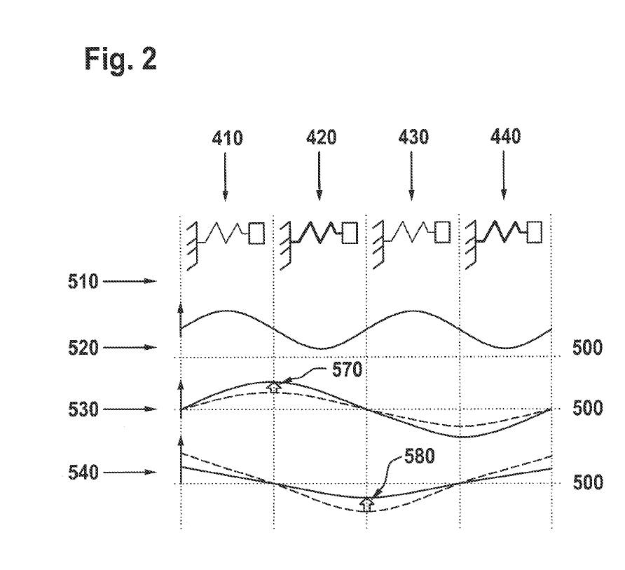

FIG. 2 shows one embodiment variant of the method according to the present invention for operating rotation rate sensor 1, which was described in FIG. 1. In the present embodiment variant, it is provided that seismic mass 2 is moved periodically in the drive direction and a deflection support voltage is present at the deflection support electrodes whose frequency is twice as high as the drive frequency. To explain the advantageous effect of the method, the movement of the seismic mass in detection direction 530 is divided into four time intervals 410, 420, 430 and 440 in FIG. 2. To illustrate the movement, the distance between the seismic mass and the drive axis is plotted against time 500. During time intervals 410 and 430, the seismic mass is in a deflection movement, and during time intervals 420 and 440, it is in a return movement. At the transitions between time intervals 410 and 420, as well as 430 and 440 (i.e., at the transitions from the deflection movement into the return movement), the seismic mass assumes the maximal distance during the deflection movement (i.e., the distance to the drive axis corresponds to the deflection amplitude). Two curves are apparent from FIG. 2 for the movement of the seismic mass in detection direction 530, the dotted curve tracing the movement of the seismic mass of rotation rate sensor 530 without the action of the deflection support means, and the solid curve representing the movement at which the deflection support means acts on the seismic mass. The comparison of the two above-mentioned curves emphasizes that the deflection amplitude with the deflection support means is advantageously greater than that which has no deflection support means (emphasized at the point denoted by reference numeral 570). For an advantageous support of the deflection movement and/or of the return movement to be possible, the action originating from deflection support means 120 must be adapted to the deflection movement of seismic mass 2 in the detection direction. The supporting force action is comparable to a spring which is aligned along the detection direction and periodically varies its spring constant 510. This is shown by the uppermost line in FIG. 2 for the four different time intervals. The spring is soft during time intervals 410 and 430, whereby seismic mass 2 is allowed to move particularly far away from the drive axis. In contrast, the spring is hard during time intervals 420 and 440, whereby the speed of the seismic mass when traversing the drive axis in the detection direction is greater than in the situation in which the spring maintains spring constant 510 from time intervals 420 and 440. In other words: to obtain a positive effect of the supporting force action on the deflection amplitude, it is provided that the spring changes its spring constant 510 twice during the deflection movement and the return movement. Spring constant 510 is not changed in the real rotation rate sensor, but preferably a deflection support voltage 520 at the deflection support electrodes is changed. The second line from the top in FIG. 2 shows how, for example, applied deflection support voltage 520 must change over time for a positive supporting force action (i.e., an action which results in an increase of the deflection amplitude) on the deflection amplitude to be achieved. It is discernible that deflection support voltage 520 does not change its sign at any point in time and periodically modulates with time 500. The modulation is carried out with a deflection support frequency which is twice as high as the drive frequency. If the supporting force action takes place in the described manner, this causes not only an increase in the deflection amplitude, but also an attenuation of a quadrature signal 540. The quadrature signal is the result of imperfections of the real rotation rate sensor which arise during the sensor's manufacture, and ensures that the measured detection signal is not only proportional to the rotation rate, but also includes contributions from the quadrature signal. The quadrature signal is in phase with the drive movement of seismic mass 2, i.e., a quadrature deflection is the greatest when the drive deflection becomes maximal. At this point in time A, i.e., at the point in time at which the seismic mass assumes the maximal distance during the deflection movement, the Coriolis force proportional to the speed of the seismic mass is the lowest (it essentially disappears). In the image of the spring extending along the detection direction and changing its spring constant, the spring is hard at the time prior to the point in time A, and thus makes a deflection in the detection direction more difficult. The quadrature deflection is thus advantageously reduced, i.e., attenuated. The lowermost line in FIG. 2 shows this effect on quadrature signal 540 based on a solid curve and a dotted curve, the solid curve representing the case when a deflection support in the detection direction takes place, and the dotted line representing the case when no deflection support in the detection direction takes place (highlighted in particular in FIG. 2 by reference numeral 580).

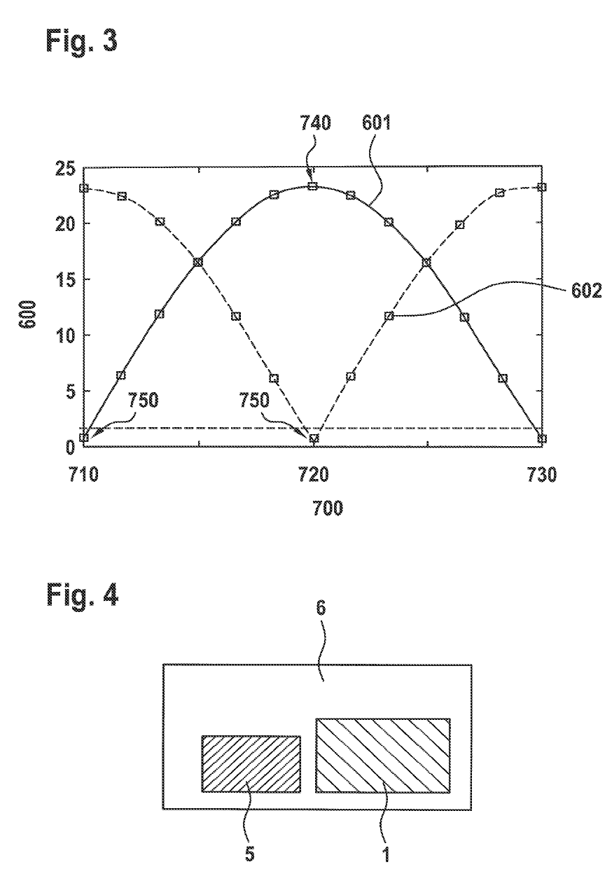

FIG. 3 represents a diagram which shows how increase 600 of deflection amplitude 601, or the attenuation of quadrature signal 602, depends on the temporal position of the periodically varying deflection support voltage relative to the oscillating movement of seismic mass 2. For this purpose, an entire oscillation/period of the deflection support voltage is observed. During this time, the detection oscillation is able to complete half an oscillation. To establish a relative position between the two oscillations (i.e., detection oscillation and deflection support voltage), one phase (i.e., the point in time within a period of the deflection support voltage) of the deflection support voltage is plotted on the x-axis at which the detection oscillation in each case assumes its maximum, i.e., the deflection amplitude. For example, the phase 180° (corresponds to reference numeral 720) corresponds to the situation in which half the period of the deflection support voltage has elapsed, and at this point in time, the deflection amplitude is assumed by the detection oscillation of seismic mass 2. It is apparent from FIG. 3 that, in this case (phase=180°, the amplification of the deflection amplitude is maximal 740 and the quadrature signal is attenuated the most (i.e., assumes a minimum 750). In contrast, if the phase corresponds to 0° (corresponds to reference numeral 710) or 360° (corresponds to reference numeral 730), the deflection amplitude is even attenuated (assuming a minimum 750) and the quadrature signal is maximally amplified.

FIG. 4 shows a device in which a rotation rate sensor 1 and an acceleration sensor 5 share an atmosphere. Acceleration sensor 5 and rotation rate sensor 1 are situated within a shared cavern 6, and acceleration sensor 5 and rotation rate sensor 1 are preferably operated according to the requirements of the acceleration sensor.

1-8. (canceled)

9. A method for operating a rotation rate sensor including a substrate and a seismic mass, comprising:
driving the seismic mass in a drive direction which extends in parallel to a main extension plane of the rotation rate sensor to carry out a drive movement; and
during a rotation of the rotation rate sensor at a rotation rate, the seismic mass being moved in a detection direction which extends perpendicularly to the drive direction and perpendicularly to the rotation rate as a result of the Coriolis force, the movement of the seismic mass in the detection direction having a deflection amplitude;
wherein the rotation rate sensor includes a deflection support element acting on the seismic mass in such a way that the deflection amplitude of the seismic mass in the detection direction is increased.

10. The method as recited in claim 9, wherein:
the seismic mass moves in the detection direction between a zero point position and the deflection amplitude;
a supporting force action transferred from the deflection support element to the seismic mass during the movement of the seismic mass from the zero point position to the deflection amplitude being greater, in sum, than a supporting force action transferred from the deflection support element to the seismic mass during the movement of the seismic mass from the deflection amplitude to the zero point position, the direction of the supporting force actions extending in parallel to the detection direction.

11. The method as recited in claim 10, wherein:
the seismic mass is driven by two drive electrodes which are situated along the drive direction;
the seismic mass is situated between the two drive electrodes; and
a drive voltage between the two drive electrodes changes periodically with a drive frequency.

12. The method as recited in claim 10, wherein:
the rotation rate sensor includes a detection element;
the detection element includes two detection electrodes which are situated along the detection direction; and
the seismic mass is situated between the two detection electrodes.

13. The method as recited in claim 10, wherein:
the deflection support element includes two deflection support electrodes which are situated in parallel to each other and along the detection direction;
the seismic mass is situated between the two deflection support electrodes; and
a deflection support voltage between the deflection support electrodes (i) maintains one of a plus or minus sign, and (ii) changes periodically with a deflection support frequency which is twice as high as the drive frequency.

14. The method as recited in claim 13, wherein the deflection support voltage has completed half of its oscillating period when the seismic mass assumes the deflection amplitude.

15. The method as recited in claim 10, wherein the rotation rate sensor includes an additional drive support element increasing a drive amplitude of the drive movement of the seismic mass in the drive direction.

16. A device comprising:
at least one rotation rate sensor including a substrate, a seismic mass, and a deflection support element acting on the seismic mass; and
at least one acceleration sensor;
wherein the rotation rate sensor and the acceleration sensor are operated in a shared atmosphere, and wherein the rotation rate sensor is configured such that:
the seismic mass is driven in a drive direction which extends in parallel to a main extension plane of the rotation rate sensor to carry out a drive movement;
during a rotation of the rotation rate sensor at a rotation rate, the seismic mass is moved in a detection direction which extends perpendicularly to the drive direction and perpendicularly to the rotation rate as a result of the Coriolis force, the movement of the seismic mass in the detection direction having a deflection amplitude; and
the deflection support element acts on the seismic mass in such a way that the deflection amplitude of the seismic mass in the detection direction is increased.
